(19) United States
(12) Patent Application Publication
(10) Pub. No.: US 2013/0247668 A1
(43) Pub. Date: Sep. 26, 2013

(54) INERTIAL SENSOR MODE TUNING CIRCUIT

(71) Applicant: Janusz Bryzek, Oakland, CA (US)

(72) Inventor: Janusz Bryzek, Oakland, CA (US)

(73) Assignee: Fairchild Semiconductor Corporation, San Jose, CA (US)

(21) Appl. No.: 13/821,619

(22) PCT Filed: Sep. 20, 2011
(86) PCT No.: PCT/US2011/052340

§ 371 Date: Jun. 13, 2013

Related U.S. Application Data
(60) Provisional application No. 61/384,322, filed on Sep. 20, 2010.

(51) Int. Cl. G01P 15/08

(52) U.S. Cl. CPC G01P 15/08
USPC 73/514.35

(57) ABSTRACT

This document discusses, among other things, an mode matching circuit for a inertial sensor including an oscillator circuit configured to selectively couple to a sense axis of an inertial sensor and to provide sense frequency information of the sense axis, a frequency comparator configured to receive the sense frequency information of the sense axis and drive frequency information of the inertial sensor, and to provide frequency difference information to a processor, and a programmable bias source configured to apply a bias voltage to the sense axis to set a sense frequency of the sense axis in response to a command from the processor, and to maintain a desired frequency difference between the sense frequency and a drive frequency of the inertial sensor.

### CLAIM OF PRIORITY

This application claims the benefit of priority to U.S. Provisional Patent Application Ser. No. 61/384,322, entitled “MODE TUNING CIRCUIT FOR MICROMACHINED MULTI-AXIS INERTIAL SENSORS,” filed on Sep. 20, 2010 (Attorney Docket No. 2921.106PRV), which is hereby incorporated by reference herein in its entirety.

### TECHNICAL FIELD

The present invention relates generally to inertial sensor devices and more particularly to mode matching circuits for inertial sensor devices.

### BACKGROUND

Inertial sensors, including microeletromechanical system (MEMS) inertial sensors can provide useful information about position and movement of the sensors. Such information can be used in mobile electronics to provide navigation information and user interface information such as for gaming applications. Performance of the sensors can depend, in part, on controlling drive and sense frequencies of the sensor. Continuous closed-loop frequency control systems have been discussed, but such system use significant power due to their continuous operation and can suffer from stability issues.

### OVERVIEW

This document discusses, among other things, a mode matching circuit for an inertial sensor including. an oscillator circuit configured to selectively couple to a sense axis of an inertial sensor and to provide sense frequency information of the sense axis, a frequency comparator configured to receive the sense frequency information of the sense axis and drive frequency information of the inertial sensor, and to provide frequency difference information to a processor, and a programmable bias source configured to apply a bias voltage to the sense axis to set a sense frequency of the sense axis in response to a command from the processor, and to maintain a desired frequency difference between the sense frequency and a drive frequency of the inertial sensor.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally a schematic cross sectional view of a 3-degrees-of-freedom (3-DOF) inertial measurement unit (IMU).

FIG. 2 illustrates generally an example of a 3-axis gyroscope.

FIG. 3 illustrates generally a system including an inertial sensor and an example mode matching circuit.

FIG. 4 illustrates generally an example method of calibrating and operating a mode matching circuit.

### DETAILED DESCRIPTION

The present inventor has recognized, among other things, a mode tuning circuit for a microelectromechanical system (MEMS) inertial sensor that can compensate for temperature and voltage sensitivity. In addition, the operation of the systems provides less complexity and can save energy over systems employing a continuous closed loop approach.

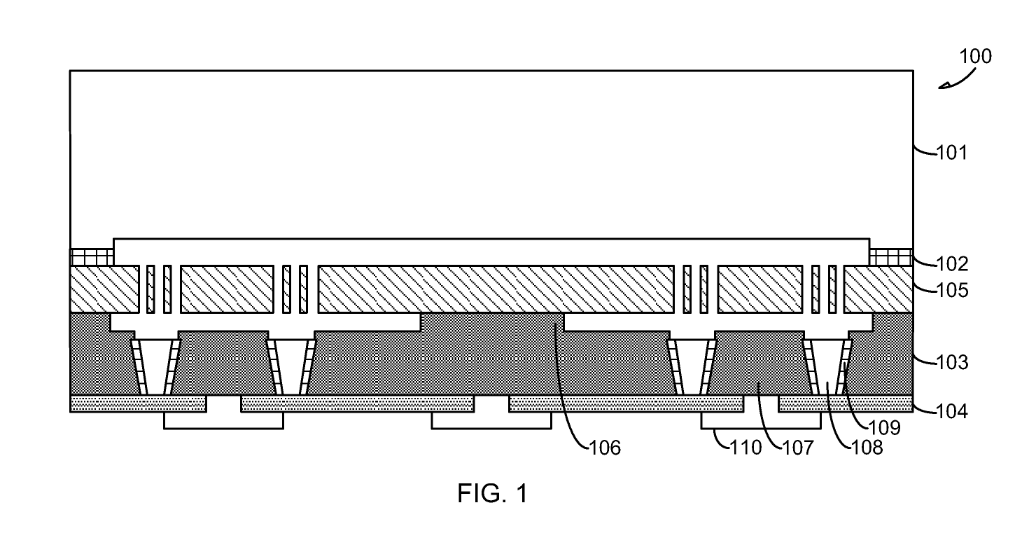

FIG. 1 illustrates generally a schematic cross sectional view of a 3-degrees-of-freedom (3-DOF) inertial measurement unit (IMU) 100, such as a 3-DOF gyroscope or a 3-DOF micromachined accelerometer, formed in a chip-scale package including a cap wafer 101, a device layer 105 including micromachined structures (e.g., a micromachined 3-DOF IMU), and a via wafer 103. In an example, the device layer 105 can be sandwiched between the cap wafer 101 and the via wafer 103, and the cavity between the device layer 105 and the cap wafer 101 can be sealed under vacuum at the wafer level.

In an example, the cap wafer 101 can be bonded to the device layer 105, such as using a metal bond 102. The metal bond 102 can include a fusion bond, such as a non-high temperature fusion bond, to allow getter to maintain long term vacuum and application of anti-stiction coating to prevent stiction that can occur to low-g acceleration sensors. In an example, during operation of the device layer 105, the metal bond 102 can generate thermal stress between the cap wafer 101 and the device layer 105. In certain examples, one or more features can be added to the device layer 105 to isolate the micromachined structures in the device layer 105 from thermal stress, such as one or more stress reducing grooves formed around the perimeter of the micromachined structures. In an example, the via wafer 103 can be bonded to the device layer 105, such as fusion bonded (e.g., silicon-silicon fusion bonded, etc.), to obviate thermal stress between the via wafer 103 and the device layer 105.

In an example, the via wafer 103 can include one or more isolated regions, such as a first isolated region 107, isolated from one or more other regions of the via wafer 103, for example, using one or more through-silicon-vias (TSVs), such as a first TSV 108 insulated from the via wafer 103 using a dielectric material 109. In certain examples, the one or more isolated regions can be utilized as electrodes to sense or actuate out-of-plane operation modes of the 6-axis inertial sensor, and the one or more TSVs can be configured to provide electrical connections from the device layer 105 outside of the system 100. Further, the via wafer 103 can include one or more contacts, such as a first contact 110, selectively isolated from one or more portions of the via wafer 103 using a dielectric layer 104 and configured to provide an electrical connection between one or more of the isolated regions or TSVs of the via wafer 103 to one or more external components, such as an ASIC wafer, using bumps, wire bonds, or one or more other electrical connection.

In certain examples, the 3-degrees-of-freedom (3-DOF) gyroscope or the micromachined accelerometer in the device layer 105 can be supported or anchored to the via wafer 103 by bonding the device layer 105 to a protruding portion of the via wafer 103, such as an anchor 106. In an example, the anchor 106 can be located substantially at the center of the via wafer 103, and the device layer 105 can be fusion bonded to the anchor 106, such as to eliminate problems associated with metal fatigue.

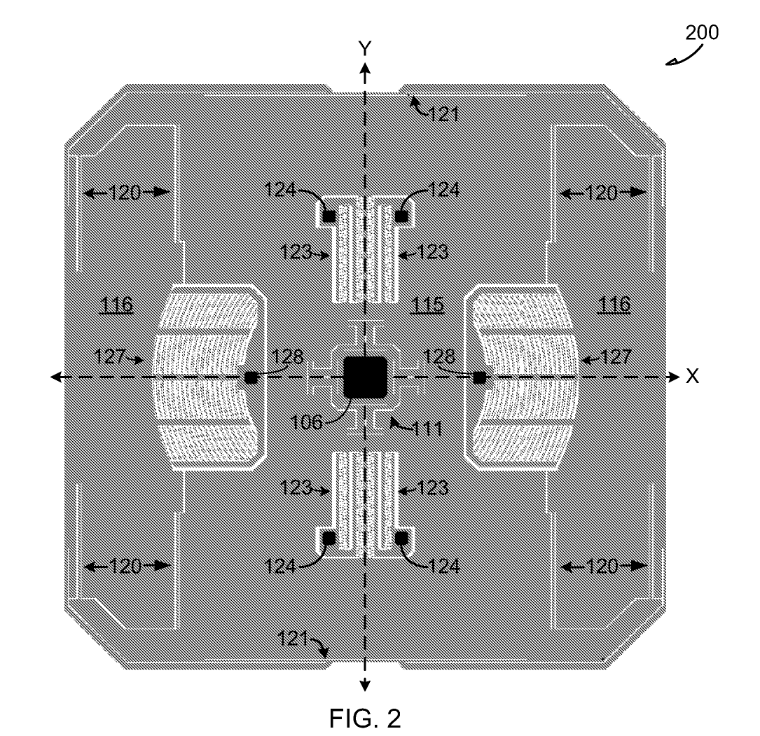

FIG. 2 illustrates generally an example of a 3-axis gyroscope 200, such as formed in a single plane of a device layer 105 of a 3-DOF IMU 100. In an example, the structure of the 3-axis gyroscope 200 can be symmetrical about the x and y axes illustrated in FIG. 2, with a z-axis conceptually coming out of the figure. Reference in FIG. 2 is made to structure and features in one portion of the 3-axis gyroscope 200. However, in certain examples, such reference and description can apply to unlabeled like portions of the 3-axis gyroscope 200.

In an example, the 3-axis gyroscope 200 can include a single proof-mass design providing 3-axis gyroscope operational modes patterned into the device layer 105 of the 3-DOF IMU 100, such as illustrated in the example of FIG. 1.

In an example, the single proof-mass can be suspended at its center using a single central anchor (e.g., anchor 106) and a central suspension 111 including symmetrical central flexure bearings (“flexures”), such as disclosed in the copending Acar et al., PCT Patent Application Serial No. US2011052006, entitled “FLEXURE BEARING TO REDUCE QUADRATURE FOR RESONATING MICROMACHINED DEVICES,” filed on Sep. 16, 2011, which is hereby incorporated by reference in its entirety. The central suspension 111 can allow the single proof-mass to oscillate torsionally about the x, y, and z axes, providing three gyroscope operational modes, including:

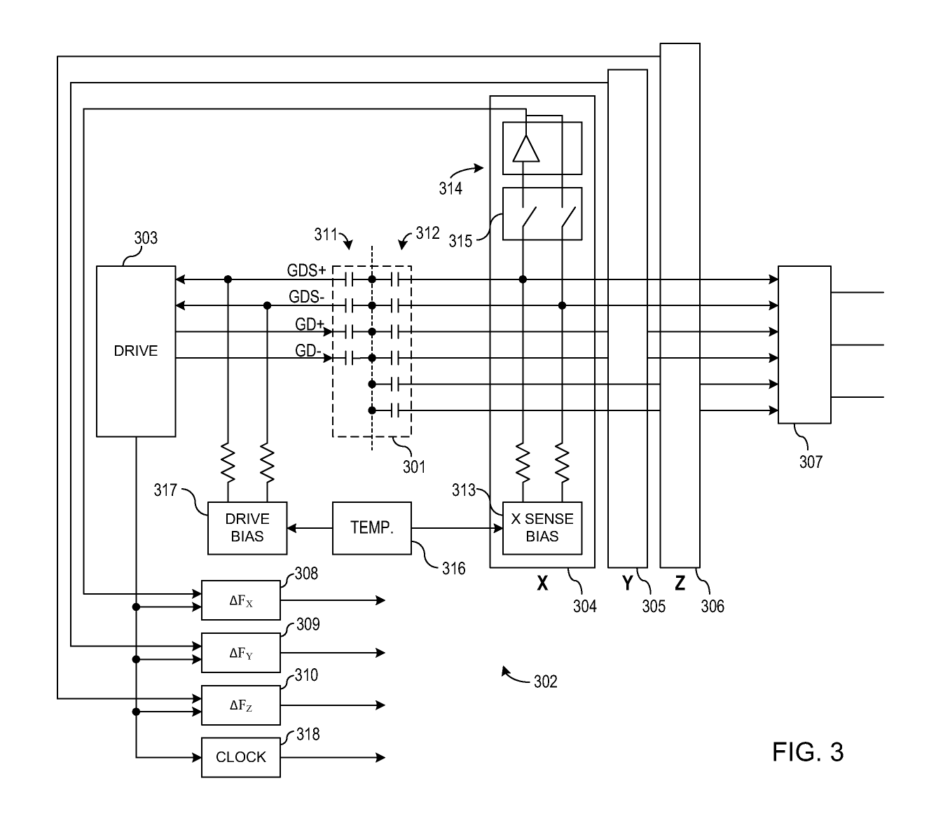

(1) Torsional in-plane drive motion about the z-axis (e.g., as illustrated in FIG. 3);

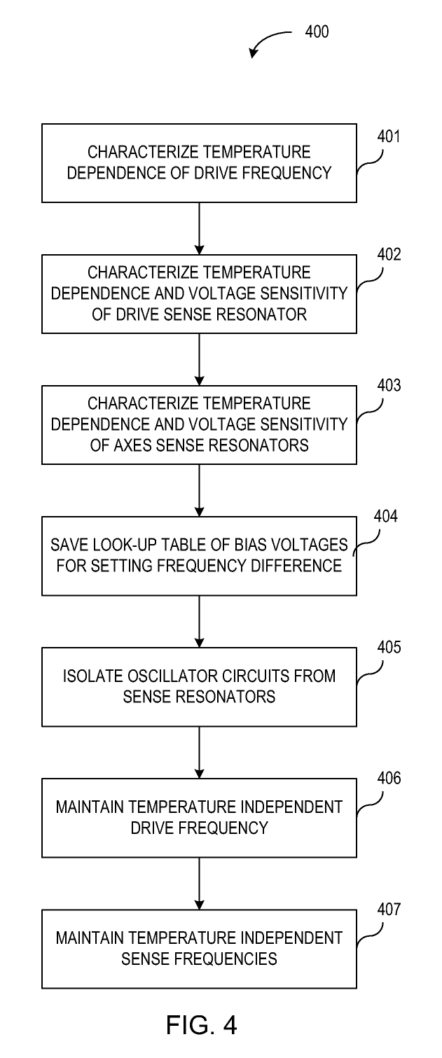

(2) Torsional out-of-plane y-axis gyroscope sense motion about the x-axis (e.g., as illustrated in FIG. 4); and

(3) Torsional out-of-plane x-axis gyroscope sense motion about the y-axis (e.g., as illustrated in FIG. 5).

Further, the single proof-mass design can be composed of multiple sections, including, for example, a main proof-mass section 115 and x-axis proof-mass sections 116 symmetrical about the y-axis. In an example, drive electrodes 123 can be placed along the y-axis of the main proof-mass section 115. In combination with the central suspension 111, the drive electrodes 123 can be configured to provide a torsional in-plane drive motion about the z-axis, allowing detection of angular motion about the x and y axes.

In an example, the x-axis proof-mass sections 116 can be coupled to the main proof-mass section 115 using z-axis gyroscope flexure bearings 120. In an example, the z-axis gyroscope flexure bearings 120 can allow the x-axis proof-mass sections 116 to oscillate linear anti-phase in the x-direction for the z-axis gyroscope sense motion.

Further, the 3-axis inertial sensor 200 can include z-axis gyroscope sense electrodes 127 configured to detect anti-phase, in-plane motion of the x-axis proof-mass sections 116 along the x-axis.

In an example, each of the drive electrodes 123 and z-axis gyroscope sense electrodes 127 can include moving fingers coupled to one or more proof-mass sections interdigitated with a set of stationary fingers fixed in position (e.g., to the via wafer 103) using a respective anchor, such as anchors 124, 128. Such interdigitated structures can form differential capacitors used to sense inertial information of each axis.

FIG. 3 illustrates generally a system 300 including an inertial sensor, such as a multi-axis MEMS inertial sensor 301 and an example mode matching circuit 302. In certain examples, the system can include a multi-axis inertial sensor, such as a multi-axis MEMS gyroscope. The mode matching circuit 302 can include a drive circuit 303, an oscillator circuit 304, 305, 306 for each sense axis, sense electronics 307 to provide inertial information to a processor (not shown), and a frequency difference circuit 308, 309, 310 for each sense axis to provide frequency difference information to the processor.

In certain examples, the inertial sensor 301 can include a drive resonator 311 configured to provide an oscillating kinetic energy in response to a received drive signal GD+, GD−. In an example, a MEMS gyroscope can include a drive resonator 311 configured to resonate in response to a signal GD+, GD− received from the drive circuit 303. In an example, the drive resonator 311 converts the signal GD+, GD− into kinetic energy by oscillating a proof mass of the MEMS gyroscope at a drive frequency. The kinetic energy provides Coriolis forces that enable the sense resonators 312 of the inertial sensor 301 to detect angular movement such as angular acceleration of the inertial sensor. In certain examples, the drive circuit 303 receives feedback GDS+, GDS− from the inertial sensor 301 and modulates the drive signal GD+, GD− to maintain amplitude stability of the drive resonator 311. In certain examples, a proof mass can couple the drive resonator 311 to the sense resonators 312. The sense resonators 312 respond to the Coriolis force and provide a sense frequency that can depend on many factors, such as manufacturing variations in material thickness, variations in gap dimensions such as gap dimensions of the proof mass, as well as other factors. Sensitivity of the inertial sensor 301 can depend on a frequency difference Δf between the drive frequency and the sense frequency. The inertial sensor 301 can have high sensitivity and high response time (narrow bandwidth) when the frequency difference is small, which can be desirable for navigation applications, for example. The inertial sensor 301 can have reduced sensitivity and lower response time (high bandwidth) when the frequency difference Δf is large, which can be desirable for gaming application, for example.

The drive circuit 303 can provide and control kinetic energy of the inertial sensor 301. In certain examples, the inertial sensor 301 can include a proof mass and the drive circuit 303 can provide kinetic energy to the inertial sensor in the form of a signal GD+, GD− that oscillates the proof mass. In an example, the drive circuit 303 can monitor the kinetic energy of the inertial sensor 301 and adjust the signal GD+, GD− to maintain predetermined characteristics of the oscillations such as maintaining amplitude stability of the proof mass oscillation.

In certain examples, it is desirable to maintain a predetermined frequency difference Δf between the drive frequency and the sense frequency. As discussed above, manufacturing variations can influence the sense frequency of the inertial sensor 301. A bias voltage can also influence both the sense frequency and the drive frequency. In certain examples, each oscillator circuit 304, 305, 306 of the mode matching circuit 302 can include a bias voltage source 313 coupled to outputs of the inertial sensor 301 to influence the sense frequency. In certain examples, the mode matching circuit 302 can include a separate bias voltage signal for each sensing axis. In certain examples, the mode matching circuit 302 can include a feedback signal indicative of the sensing frequency of each sensing axis. In an example, the mode matching circuit 302 can include a frequency difference circuit 308, 309, 310 that can compare the sensing frequency to the drive frequency and can provide an output indicative of the frequency difference Δf. In certain systems, a processor or state machine can receive the output of the frequency difference circuit 308, 309, 310 and can modulate a programmable bias voltage source (e.g. 313) to set a sensing frequency that provides a desired frequency difference, Δf. In certain examples, the feedback circuit 314 can include a switch 315 such that the feedback from the sense electrodes of the inertial sensor 301 to the frequency comparators 308, 309, 310 can be enabled during a calibration process and disabled at other times such as when the inertial sensor 301 is used to provide gyroscopic information. In certain examples, each sensing axis X, Y, Z can include a feedback circuit, switch and programmable bias voltage source to set the sensing frequency for the respective sensing axis.

In certain examples, the mode matching circuit 302 can include a temperature sensor 316 to provide temperature feedback. In such examples, such as during a calibration process, the influence of temperature on the sensing frequency can be measured and recorded. During operation, temperature can be monitored and the sensing frequency can be adjusted using the programmable bias voltage sources (e.g., 313) such that a stable predetermined frequency difference Δf can be maintained. In certain examples, the sense frequency of each axis of the MEMS inertial sensor 301 can be calibrated and maintained without continuously monitoring the sense frequency, thus, providing substantial energy savings and circuit space savings. In certain examples, the sense frequency can be monitored periodically, for example, by a corresponding device processor, to ensure that the desired frequency difference Δf is maintained, or to adjust the sense frequency to match a corresponding change in the desired frequency difference, or to compensate for long term drift effects.

In certain examples, the inertial sensor 301 can be used for more than one application. For example, a multi-axis MEMS inertial sensor 301 can be used in mobile electronic devices that include navigation and gaming applications. As discussed above, the frequency difference Δf between the drive frequency and the sense frequency of the MEMS inertial sensor 301 can determine how well a sensor can perform in certain applications. In certain examples, the mode matching circuit 302 can include a drive resonator programmable bias source 317. The drive resonator programmable bias source 317 can be programmed to influence the drive frequency of the multi-axis MEMS sensor 301. For example, when a user executes a navigation application, a predetermined a bias voltage can be applied to the drive resonator 311 to move the drive frequency closer to the sense frequency to provide better inertial information sensitivity. In another example, when a user executes a gaming application, a predetermined bias voltage can be applied to the drive resonator 311 to move the drive frequency away from the sense frequency to provide better inertial information response. Such adjustment of the frequency difference Δf to the application using the inertial information can be called “mode matching”. In certain applications, a mode matching circuit 302 can use both the drive resonator programmable bias source 317 and the one or more programmable bias sources e.g., 313 corresponding to the sense axes to adjust the frequency difference Δf.

In certain applications, the mode matching circuit 302 can include a frequency calibration circuit 318 to receive a periodic signal from the drive circuit 303 and process the signal to provide a clock signal to other circuitry, such as the processor or state machine that receives the inertial information from the MEMS inertial sensor 301. Such a configuration can eliminate the use of a dedicated clock circuit.

FIG. 4 illustrates generally an example method 400 of calibrating a mode matching circuit. At 401, the temperature dependence of the drive frequency can be characterized and recorded. At 402, the temperature dependence and voltage sensitivity of the drive sense resonator can be characterized. In an example, the temperature dependence and voltage sensitivity of the drive sense resonator can be characterized by measuring drive frequency with various bias voltages and temperatures. At 403, the temperature dependence and voltage sensitivity of the axes sense resonator can be characterized. In certain examples, characterizing the temperature dependence and voltage sensitivity of the axes sense resonator can include coupling an oscillator circuit to each axis to create a self oscillation of each axis resonator. Using one of the differential capacitors to actuate the resonant movement and the other differential capacitor to sense the resonant frequency. Characterization of each axis sense resonator can include measuring the resonant frequency for various temperatures and bias voltages. At 404, a look-up table or algorithms can be saved to a processor, a state machine, or the bias sources to assist in setting the bias voltage for a particular frequency difference at a particular temperature. At 405, during sensing operation of the inertial sensor, the oscillator circuits can be isolated from the axis sense resonators such as by switching a switch. At 406, a programmable drive bias source can maintain a desired, temperature-independent drive frequency using information received from a temperature sensor. At 407, one or more programmable axis bias sources can maintain respective desired, temperature-independent frequency difference using the temperature information to maintain the desired sense frequency. In certain examples, a self calibration mode can be initiated to compensate for long term drift issues.

In certain examples, at least a portion of the mode matching circuit can be part of an integrated circuit. In an example, the mode matching circuit can be implemented as part of a controller associated with the inertial sensor such as an application-specific integrated circuit (ASIC) associated with the inertial sensor.

### Additional Notes and Examples

In Example 1, a mode matching circuit can include an oscillator circuit configured to selectively couple to a sense axis of an inertial sensor and to provide sense frequency information of the sense axis, a frequency comparator configured to receive the sense frequency information of the sense axis and drive frequency information of the inertial sensor, and to provide frequency difference information to a processor, and a programmable bias source configured to apply a bias voltage to the sense axis to set a sense frequency of the sense axis in response to a command from the processor, and to maintain a desired frequency difference between the sense frequency and a drive frequency of the inertial sensor.

In Example 2, the mode matching circuit of Example 1 optionally includes a switch to couple the oscillator circuit to the sense axis.

In Example 3 the mode matching circuit of any one or more of Examples 1-2 optionally includes a second oscillator circuit configured to selectively couple to a second sense axis of the inertial sensor, a second frequency comparator configured to receive an output of the second oscillator circuit indicative of a second sense frequency of the second sense axis and the drive frequency information, and to provide second frequency difference information to the processor, and a second programmable bias source configured to apply a second bias voltage to the second sense axis to set the second sense frequency in response to a second command from the processor and to maintain a second desired frequency difference between the second sense frequency and the drive frequency of the inertial sensor.

In Example 4, the mode matching circuit of any one or more of Examples 1-3 optionally includes a drive circuit configured to provide kinetic energy to the inertial sensor and to provide the drive frequency information.

In Example 5, the mode matching circuit of any one or more of Examples 1-4 optionally includes a programmable drive resonator bias source configured to apply a drive bias to a drive resonator of the inertial sensor and to modulate the drive bias to adjust the desired frequency difference.

In Example 6, the mode matching circuit of any one or more of Examples 1-5 optionally includes a temperature sensor, wherein the drive circuit of any one or more of Examples 1-5 is optionally configured to maintain a desired drive frequency using the drive bias in response to temperature information received from the temperature sensor.

In Example 7, the mode matching circuit of any one or more of Examples 1-6 optionally includes a temperature sensor, wherein the programmable bias source of any one or more of Examples 1-6 is optionally configure to maintain the desired frequency difference using the bias voltage in response to temperature information received from the temperature sensor.

In Example 8, a method can include selectively coupling an oscillator circuit to a sense axis of an inertial sensor. providing sense frequency information of the sense axis using the oscillator circuit, receiving the sense frequency information and drive frequency information of the inertial sensor at a frequency comparator, providing frequency difference information to a processor using the frequency comparator, receiving a command from the processor at a programmable bias source, applying a bias voltage to the sense axis to set a sense frequency of the sense axis, and maintaining a desired frequency difference between the sense frequency and a drive frequency of the inertial sensor using the bias voltage.

In Example 9, the selectively coupling the oscillator circuit to the sense axis of any one or more of Examples 1-8 optionally includes actuating a switch.

In Example 10 the method of any one or more of Examples 1-9 optionally includes selectively coupling a second oscillator circuit to a second sense axis of the inertial sensor, providing second sense frequency information of the second sense axis using the second oscillator circuit, receiving the second sense frequency information and the drive frequency information of the inertial sensor at a second frequency comparator, providing second frequency difference information to the processor using the second frequency comparator, receiving a second command from the processor at a second programmable bias source, applying a second bias voltage to the second sense axis to set a second sense frequency, and maintaining a second desired frequency difference between the second sense frequency and the drive frequency of the inertial sensor using the second bias voltage.

In Example 11, the method of any one or more of Examples 1-10 optionally includes providing kinetic energy to the inertial sensor using a drive circuit.

In Example 12, the method of any one or more of Examples 1-11 optionally includes receiving drive feedback information from the inertial sensor at the drive circuit, and providing the drive frequency information using the drive feedback information.

In Example 13, the method of any one or more of Examples 1-12 optionally includes applying a drive bias to a drive resonator of the inertial sensor, and modulating the drive bias adjust the desired frequency difference.

In Example 14, the method of any one or more of Examples 1-13 optionally includes receiving temperature information from a temperature sensor, and maintaining a desired drive frequency using the drive bias and the temperature information.

In Example 15, the method of any one or more of Examples 1-14 optionally includes receiving temperature information from a temperature sensor, and maintaining the desired frequency difference using the bias voltage applied to the sense axis and the temperature information.

In Example 16, the method of any one or more of Examples 1-15 optionally includes providing a clock signal to the processor using the drive frequency information.

In Example 17, a system can include an inertial sensor and a mode matching circuit. The mode matching circuit can include an oscillator circuit configured to selectively couple to a sense axis of the inertial sensor and to provide sense frequency information of the sense axis, a frequency comparator configured to receive the sense frequency information of the sense axis and drive frequency information of the inertial sensor, and to provide frequency difference information to a processor, and a programmable bias source configured to apply a bias voltage to the sense axis to set a sense frequency of the sense axis in response to a command from the processor, and to maintain a desired frequency difference between the sense frequency and a drive frequency of the inertial sensor.

In Example 18, the inertial sensor of any one or more of Examples 1-18 optionally includes a microelectromechanical system (MEMS) inertial sensor.

In Example 19, the inertial sensor of any one or more of Examples 1-18 optionally includes a multi-axis inertial sensor.

In Example 20, the inertial sensor of any one or more of Examples 1-19 optionally includes a 3-axis MEMS gyroscope.

In Example 21, a system or apparatus can include, or can optionally be combined with any portion or combination of any portions of any one or more of Examples 1-20 to include, means for performing any one or more of the functions of Examples 1-20, or a machine-readable medium including instructions that, when performed by a machine, cause the machine to perform any one or more of the functions of Examples 1-20.

The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. In other examples, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A mode matching circuit comprising:
an oscillator circuit configured to selectively couple to a sense axis of an inertial sensor and to provide sense frequency information of the sense axis;
a frequency comparator configured to receive the sense frequency information of the sense axis and drive frequency information of the inertial sensor, and to provide frequency difference information to a processor; and
a programmable bias source configured to apply a bias voltage to the sense axis to set a sense frequency of the sense axis in response to a command from the processor, and to maintain a desired frequency difference between the sense frequency and a drive frequency of the inertial sensor.

2. The mode matching circuit of claim 1, including a switch to couple the oscillator circuit to the sense axis.

3. The mode matching circuit of claim 1, including:
a second oscillator circuit configured to selectively couple to a second sense axis of the inertial sensor;
a second frequency comparator configured to receive an output of the second oscillator circuit indicative of a second sense frequency of the second sense axis and the drive frequency information, and to provide second frequency difference information to the processor; and
a second programmable bias source configured to apply a second bias voltage to the second sense axis to set the second sense frequency in response to a second command from the processor and to maintain a second desired frequency difference between the second sense frequency and the drive frequency of the inertial sensor.

4. The mode matching circuit of claim 1, including a drive circuit configured to provide kinetic energy to the inertial sensor and to provide the drive frequency information.

5. The mode matching circuit of claim 1, including a programmable drive resonator bias source configured to apply a drive bias to a drive resonator of the inertial sensor and to modulate the drive bias to adjust the desired frequency difference.

6. The mode matching circuit of claim 5 including a temperature sensor, wherein the is configured to maintain a desired drive frequency using the drive bias in response to temperature information received from the temperature sensor.

7. The mode matching circuit of claim 1, including a temperature sensor, wherein the programmable bias source is configure to maintain the desired frequency difference using the bias voltage in response to temperature information received from the temperature sensor.

8. A method comprising:
selectively coupling an oscillator circuit to a sense axis of an inertial sensor;
providing sense frequency information of the sense axis using the oscillator circuit;
receiving the sense frequency information and drive frequency information of the inertial sensor at a frequency comparator;
providing frequency difference information to a processor using the frequency comparator;
receiving a command from the processor at a programmable bias source;
applying a bias voltage to the sense axis to set a sense frequency of the sense axis; and
maintaining a desired frequency difference between the sense frequency and a drive frequency of the inertial sensor using the bias voltage.

9. The method of claim 8, wherein the selectively coupling the oscillator circuit to the sense axis includes actuating a switch.

10. The method of claim 8, including:
selectively coupling a second oscillator circuit to a second sense axis of the inertial sensor;
providing second sense frequency information of the second sense axis using the second oscillator circuit;
receiving the second sense frequency information and the drive frequency information of the inertial sensor at a second frequency comparator;
providing second frequency difference information to the processor using the second frequency comparator;
receiving a second command from the processor at a second programmable bias source;
applying a second bias voltage to the second sense axis to set a second sense frequency; and
maintaining a second desired frequency difference between the second sense frequency and the drive frequency of the inertial sensor using the second bias voltage.

11. The method of claim 8, including providing kinetic energy to the inertial sensor using a drive circuit.

12. The method of claim 11, including
receiving drive feedback information from the inertial sensor at the drive circuit; and
providing the drive frequency information using the drive feedback information.

13. The method of claim 8, including:
applying a drive bias to a drive resonator of the inertial sensor; and
modulating the drive bias adjust the desired frequency difference.

14. The method of claim 13, including:
receiving temperature information from a temperature sensor; and
maintaining a desired drive frequency using the drive bias and the temperature information.

15. The method of claim 8, including:
receiving temperature information from a temperature sensor; and
maintaining the desired frequency difference using the bias voltage applied to the sense axis and the temperature information.

16. The method of claim 8, including providing a clock signal to the processor using the drive frequency information.

17. A system comprising:
an inertial sensor; and
a mode matching circuit including
an oscillator circuit configured to selectively couple to a sense axis of the inertial sensor and to provide sense frequency information of the sense axis;
a frequency comparator configured to receive the sense frequency information of the sense axis and drive frequency information of the inertial sensor, and to provide frequency difference information to a processor; and
a programmable bias source configured to apply a bias voltage to the sense axis to set a sense frequency of the sense axis in response to a command from the processor, and to maintain a desired frequency difference between the sense frequency and a drive frequency of the inertial sensor.

18. The system of claim 17, wherein the inertial sensor includes a microelectromechanical system (MEMS) inertial sensor.

19. The system of claim 17, wherein the inertial sensor includes a multi-axis inertial sensor.

20. The system of claim 17, wherein the inertial sensor includes a 3-axis MEMS gyroscope.
